(19) United States
(12) Patent Application Publication
(10) Pub. No.: US 2025/0114736 A1
(43) Pub. Date: Apr. 10, 2025

(54) CARBON DIOXIDE CAPTURE APPARATUS, LOGIC CONTROL SYSTEM, AND METHODS THEREOF

(71) Applicant: Avnos, Inc., Los Angeles, CA (US)

(72) Inventors: Yanhui Yuan, Erie, CO (US); Alexander Constantin Spiteri, Toronto (CA); Neel Rangnekar, Jersey City, NJ (US); Benjamin A. McCool, Annandale, NJ (US); Ronald R. Chance, Louisville, CO (US)

(21) Appl. No.: 18/904,914

(22) Filed: Oct. 2, 2024

Related U.S. Application Data
(60) Provisional application No. 63/542,453, filed on Oct. 4, 2023.
(60) Provisional application No. 63/647,871, filed on May 15, 2024.

(51) Int. Cl. B01D 53/04; B01D 53/047; B01D 53/26

(52) U.S. Cl. CPC B01D 53/0454; B01D 53/0462; B01D 53/047; B01D 53/261; B01D 2253/202; B01D 2253/204; B01D 2257/504; B01D 2257/80; B01D 2258/06; B01D 2259/40007; B01D 2259/40086

(57) ABSTRACT

Apparatuses and methods for providing carbon dioxide direct air capture (DAC) systems to improve energy efficiency, operability, and economic performance of DAC technologies based on several types of approaches including temperature swing adsorption (TSA), pressure swing adsorption (PSA), and moisture swing adsorption (MSA) are disclosed. In particular, DAC apparatuses including a first water extraction unit, a process unit comprising a second water extraction unit, a carbon dioxide capture unit, and a water release unit are disclosed. The present disclosure also provides a logic control system for a preconditioner for the proposed DAC apparatus, including a controller, and one or more control elements in communication with the fluid streams, where the controller is configured to adjust temperature, water content, or combination thereof of the second fluid stream, third fluid stream, or both to pre-determined ranges based on the cost to capture carbon dioxide on a net removal basis.

### INCORPORATION BY REFERENCE TO ANY PRIORITY APPLICATIONS

Any and all applications for which a priority claim is identified in the Application Data Sheet as filed with the present application are hereby incorporated by reference under 37 CFR 1.57.

### FIELD

The present disclosure relates to the field of direct air capture (DAC) for capturing carbon dioxide (CO₂) from ambient air.

### BACKGROUND

Direct air capture (DAC) refers to the use of chemical or physical processes and corresponding apparatuses to extract carbon dioxide from the ambient air. In general, a DAC apparatus includes a carbon dioxide sorbent that adsorbs carbon dioxide from ambient air and then, in response to an external stimulus, releases carbon dioxide, thereby regenerating the sorbent. Several types of DAC apparatuses are known. They include temperature swing adsorption (TSA) units, whereby temperature induces carbon dioxide release; pressure swing adsorption (PSA) units, whereby pressure induces carbon dioxide release; and moisture swing adsorption (MSA) units, whereby moisture contacting the sorbent induces carbon dioxide release.

Hybrid direct air capture (HDAC) apparatuses and processes are also known. A HDAC apparatus is a type of DAC apparatus in which the carbon dioxide capture unit or carbon capture unit is combined with an atmospheric water extraction (AWE) unit. The AWE unit removes moisture from a fluid stream before the fluid stream contacts the carbon capture unit.

Generally, several factors significantly affect carbon dioxide sorbent performance in DAC and HDAC processes and apparatuses. Among the factors, temperature, moisture, and carbon dioxide concentrations in ambient air are important to DAC process efficiency. However, it can be energy intensive to manage these factors to sustain economically reasonable DAC operability. This is particularly true given that these factors can vary depending on geographical location, time of day, ambient weather conditions, and type of carbon dioxide sorbent.

### SUMMARY

Disclosed herein is an apparatus that includes:
(A) a first water extraction unit configured to receive an ambient air stream comprising water and carbon dioxide and to adsorb water from the ambient air stream at atmospheric pressure to form a second fluid stream having a water content less than the water content of the ambient air stream;
(B) a process unit comprising a second water extraction unit downstream of the first water extraction unit and a carbon capture unit downstream of the second water extraction unit, wherein the process unit is capable of reversibly operating in (a) capture mode to adsorb water and carbon dioxide from an incoming fluid stream and (b) regeneration mode to release adsorbed water and carbon dioxide, where the process unit is configured such that:
(a) during capture mode (i) the second water extraction unit receives the second fluid stream from the first water extraction unit and adsorbs water from the second fluid stream to form a third fluid stream having a water content less than the water content of the second fluid stream; and (ii) the carbon capture unit receives the third fluid stream and adsorbs carbon dioxide from the third fluid stream to form a fourth fluid stream having a carbon dioxide content that is less than the carbon dioxide content of the third fluid stream; and
(b) during release mode the carbon capture unit, on exposure to water vapor, heat, pressure, or a combination thereof, releases adsorbed carbon dioxide to form a fifth fluid stream comprising carbon dioxide and water; and
(C) a water release unit downstream of the process unit configured to receive the fourth fluid stream from the carbon capture unit and (a) combine the fourth fluid stream with adsorbed water from the first water extraction unit to form a sixth fluid stream and (b) release the sixth fluid stream back into atmosphere.

In some embodiments, the process unit is configured to switch between capture mode and release mode at a prescribed operational frequency.

In some embodiments, the first water extraction unit and the water release unit are configured to form an enthalpy wheel. The enthalpy wheel may be configured to rotate at a speed ranging from about 1 rotation/minute to about 50 rotations/minute.

In some embodiments, at least one of the first water extraction unit, the second water extraction unit, and the water release unit includes a desiccant bed comprising a moisture sorbent. In some embodiments, at least one of the first water extraction unit, the second water extraction unit, and the water release unit includes a desiccant bed comprising a bifunctional sorbent.

In some embodiments, the carbon capture unit includes a sorbent bed comprising a carbon dioxide sorbent. In some embodiments, the carbon capture unit includes a sorbent bed comprising a bifunctional sorbent. The carbon capture unit may be a moisture swing adsorption unit, a pressure swing adsorption unit, or a temperature swing adsorption unit.

In some embodiments, the apparatus is configured to control the temperature, the water content, or combination thereof of the second fluid stream, third fluid stream, or both within pre-determined ranges. For example, the apparatus may further include a logic control system for controlling the temperature, the water content, or combination thereof of the second fluid stream, third fluid stream, or both within pre-determined ranges in real time.

The logic control system includes: (a) a controller; and (b) at least one control element in communication with the ambient air stream, second fluid stream, third fluid stream, or combination thereof. The controller is configured to adjust the temperature, the water content, or combination thereof of the second fluid stream, third fluid stream, or both to pre-determined ranges based on the cost to capture carbon dioxide on a net removal basis.

In some embodiments, the controller includes a processor and a memory comprising computer-readable instructions to adjust the pre-determined ranges via a control cycle. The control cycle includes:
(a) receiving at least one measurement of the temperature, the water content, or combination thereof of the ambient air stream, second fluid stream, third fluid stream, or combination thereof from at least one sensor in communication with the ambient air stream, second fluid stream, third fluid stream, or combination thereof;
(b) determining, by the controller, whether the at least one measurement is within the pre-determined range; and
(c) transmitting at least one control signal to at least one control element. The at least one control element is configured to actuate upon receiving the at least one control signal to adjust the temperature, the water content, or combination thereof of the ambient air stream, second fluid stream, third fluid stream, or combination thereof.

There is also disclosed herein a system that includes a pair of the above-described apparatuses. The process unit of the first apparatus operates in capture mode when the process unit of the second apparatus operates in release mode, and the process unit of the first apparatus operates in release mode when the process unit of the second apparatus operates in capture mode. This novel configuration enables near continuous production of CO₂ and water and additional opportunities for heat integration compared to the single unit (batch production) mode, thus providing lower energy consumption and lower cost of capture. The first apparatus and second apparatus are configured such that:
(a) the fourth fluid stream of the first apparatus combines with adsorbed water from the first water extraction unit of the second apparatus to form a sixth fluid stream of the first apparatus released to atmosphere and
(b) the fourth fluid stream of the second apparatus combines with adsorbed water from the first water extraction unit of the first apparatus to form a sixth fluid stream of the second apparatus released to the atmosphere.

Also disclosed are methods of using the above-described apparatuses to capture carbon dioxide from ambient air.

The apparatuses and processes disclosed herein offer several advantages. They pre-condition the incoming ambient air stream, thereby enhancing the performance and overall carbon capture efficiency of the DAC unit. This, in turn, enables large volumes of air to be processed effectively and efficiently. Moreover, the apparatuses and processes disclosed herein can adjust the properties of the incoming ambient air stream, preferably in real time. This enables the apparatus and process to adapt to changing environmental conditions (e.g., geographical location, time of day, daily weather), and the type of carbon dioxide sorbent.

### BRIEF DESCRIPTION OF THE DRAWINGS

In the following, exemplary embodiments of the present disclosure will be described with reference to the drawings.

FIG. 1 is a schematic illustration of an example U-shaped DAC apparatus according to the present disclosure.

FIG. 2 is a schematic illustration of an example double-module DAC apparatus according to the present disclosure.

FIG. 3 is a schematic illustration of an example heat pump process for supplying heat to the second water extraction unit for regeneration of the second water extraction unit.

FIG. 4A is a schematic illustration of an example carbon DAC apparatus configured to supply heat to the air flow of ambient air with a heat pump cycle during low temperature ambient air conditions.

FIG. 4B is a schematic illustration of an example carbon DAC apparatus configured to supply heat to the air flow of ambient air with a heat exchanger during low temperature ambient air conditions.

FIGS. 5A-5C is an illustration showing a measured temperature and humidity distribution, including occurrence frequency in three different locations (FIG. 5A: Bakersfield, California, FIG. 5B: Geismar, Louisiana, FIG. 5C: Stenlille, Denmark) over the course of 1 year.

FIG. 6A illustrates the results of a heat and mass balance (HMB) process model calculation of levelized cost of capture (LCOC) for an example MSA-DAC operation in Geismar, Louisiana.

FIG. 6B illustrates the results of an HMB process model calculation of energy consumption for the example MSA-DAC operation of FIG. 6A and includes illustration of the optimal or target zone for MSA-DAC operation in Geismar, Louisiana.

FIG. 7 is a schematic illustration of an example workflow of the logic control system of the present disclosure.

FIG. 8 is a schematic illustration of an example workflow of the logic control system of the present disclosure.

FIG. 9 illustrates an example psychrometric chart of ambient air and an example optimal or target zone for temperature and relative humidity according to some embodiments of the present disclosure.

FIG. 10 illustrates the results of an HMB process model calculation of total heat transfer efficiency as a function of rotational speed of an example enthalpy wheel according to the present disclosure.

FIGS. 11A-11C illustrates the results of an HMB process model optimization of a mass ratio of total water harvested from the fluid stream to total water consumed in CO₂ desorption to a target value.

### DETAILED DESCRIPTION

### DAC Apparatus and Preconditioner for DAC

According to the present disclosure, a carbon dioxide capture apparatus includes a first water extraction unit, a second water extraction unit, a carbon dioxide capture unit, and a water release unit.

The carbon dioxide capture apparatus is configured to operate in a first operating mode and a second operating mode. In the first operating mode, the apparatus extracts carbon dioxide from ambient air. Therefore, the first operating mode can be referred to as a carbon dioxide capture mode. In the second operating mode, the apparatus regenerates to renew its capability of being operated in the first operating mode to capture carbon dioxide. Therefore, the second operating mode can be referred to as a regeneration or release mode.

The first water extraction unit is configured to operate in a cyclical water extraction/release mode with respect to a directed flow of ambient air. The cyclical operation refers to the first operating mode and the second operating mode whereby the apparatus is operated periodically in the first operating mode in which the first water extraction unit extracts water from the air flow and in the second operating mode in which the first water extraction unit releases the extracted water. The first water extraction unit extracts water from the air flow drawn from ambient air during the first operating mode of the apparatus and releases water during the second operating mode of the apparatus.

The second water extraction unit is arranged downstream of the first water extraction unit in a flow direction of the air flow in the first operating mode of the apparatus. The second water extraction unit is configured to operate in a cyclical water extraction/release mode with respect to the air flow. The second water extraction unit extracts water from the air flow during the first operating mode of the apparatus and releases water during the second operating mode of the apparatus. In a preferred embodiment for the water extraction units, the water adsorbent is a desiccant capable of reversible adsorption of water in the operating system described herein. Other reversible water adsorption system alternatives would be known to those skilled in the art.

The released water, which has been harvested from the air flow, can be used for the carbon dioxide capture unit (e.g., a MSA or TSA carbon dioxide capture unit). By using the harvested water for the carbon dioxide capture unit, water usage per weight unit (e.g., ton) of captured carbon dioxide can be reduced.

The carbon dioxide capture unit is arranged downstream of the second water extraction unit in the flow direction of the air flow in the first operating mode of the apparatus, i.e., during the carbon dioxide capturing operation of the apparatus. The carbon dioxide capture unit is configured to operate in a cyclical carbon dioxide capture/release mode with respect to a dehumidified air of the air flow provided by the second water extraction unit. The carbon dioxide capture unit captures carbon dioxide in the first operating mode of the apparatus and releases carbon dioxide in the second operating mode of the apparatus. The dehumidified air flow is the air flow that is output by the second water extraction unit from which water has been extracted in the first operating mode of the apparatus. By extracting water from the air flow, the air flow is preconditioned for the carbon dioxide capture process in the carbon dioxide capture unit. Accordingly, the carbon dioxide capture process needs less energy and has lower costs for capturing a ton (or any other weight unit) of carbon dioxide. The carbon dioxide capture unit employs water extraction to improve the efficiency (e.g., based on energy consumption and capital utilization) of the DAC process.

The carbon dioxide capture unit can be of any type. For example, the carbon dioxide capture unit can be a moisture swing adsorption (MSA) type unit, a pressure swing adsorption (PSA) type unit, or a temperature swing adsorption (TSA) type unit.

The water release unit is arranged downstream of the carbon dioxide capture unit in the flow direction of the air flow in the first operating mode of the apparatus, i.e., during the carbon dioxide capturing operation of the apparatus. The water release unit is configured to operate in a cyclical water release/extraction mode with respect to the air flow. The water release unit releases water during the first operating mode of the apparatus and extracts water from the air flow during the second operating mode of the apparatus.

The sequence of the four units in the apparatus from the inlet of the apparatus to the outlet of the apparatus (i.e. in the flow direction of the air flow) during the first operating mode of the apparatus is: first water extraction unit→second water extraction unit→carbon dioxide capture unit→water release unit. This sequence of the four units includes i) the case that no other component of the apparatus is interposed between the four units, and ii) the case that other components of the apparatus can be interposed between the four components. In other words, the air flow first flows through the first water extraction unit, then flows through the second water extraction unit, then flows through the carbon dioxide capture unit, and then flows through the water release unit in the first operating mode of the apparatus.

The first water extraction unit may include a first desiccant bed including a first water selective sorbent. The first water selective sorbent is configured to extract water from the air flow during the first operating mode of the apparatus. Further, the first water selective sorbent is configured to release water during the second operating mode of the apparatus.

The second water extraction unit may include a second desiccant bed including a second water selective sorbent. The second water selective sorbent can be the same as, or different from, the first water selective sorbent. The second water selective sorbent is configured to extract water from the air flow during the first operating mode of the apparatus. Further, the second water selective sorbent is configured to release water during the second operating mode of the apparatus. The second water extraction unit may provide more constant air flow conditions, such as relative humidity, of the air flow to the carbon dioxide capture unit than the first water extraction unit. For example, typical ambient air relative humidity can vary 30% during a day, while the air flow supplied by the second water extraction unit to the carbon dioxide capture unit will only vary 5% or less.

The carbon dioxide capture unit includes a carbon dioxide sorbent system including a carbon dioxide sorbent. The carbon dioxide sorbent system is configured to capture carbon dioxide from the dehumidified air of the air flow provided by the second water extraction unit during the first operating mode of the apparatus. The carbon dioxide sorbent system is configured to release carbon dioxide during the second operating mode of the apparatus.

The water release unit includes a third desiccant bed including a third water selective sorbent. The third water selective sorbent can be the same as one or more of the first water selective sorbent or the second water selective sorbent. The third water selective sorbent is configured to release extracted or adsorbed water back to the air flow during the first operating mode of the apparatus. Further, the third water selective sorbent is configured to extract water from the air flow during the second operating mode of the apparatus.

Any of the first, second, and third water selective sorbents (e.g., water selective sorbent beds or water selective sorbent units) may be gas-solid or gas-liquid contactors. In some embodiments, any of the first, second, and third water selective sorbents may be of the same type. In other words, the first, second, and third water selective sorbents (e.g., water selective sorbent beds or water selective sorbent units) may all be gas-solid or gas-liquid contactors.

The first water selective sorbent, and/or the second water selective sorbent, and/or the third water selective sorbent may be a desiccant material or bifunctional sorbent material configured to extract both water (H₂O) and carbon dioxide (CO₂) from the air flow. In some embodiments, at least one of the first water extraction unit, the second water extraction unit, and the water release unit includes a desiccant bed comprising the bifunctional sorbent. In some embodiments, the carbon capture unit includes a sorbent bed comprising the bifunctional sorbent. The first water selective sorbent, and/or the second water selective sorbent, and/or the third water selective sorbent may operate to further boost the concentration of carbon dioxide in the air flow provided to the carbon dioxide capture unit. The first water selective sorbent, and/or the second water selective sorbent, and/or the third water selective sorbent may operate to increase an overall capture efficiency of carbon dioxide of the apparatus.

Generally, the first, second, and third desiccant bed/water selective sorbent can all be of the same type or only two can be of the same type, or they all can be of a different type described herein.

The first and/or second and/or third desiccant bed/water selective sorbent can be commercial desiccants, such as silica gel, zeolites, and polymer desiccants, or advanced water sorbents that only absorb water at certain range of relative humidity. For example, water selective sorbents can be MIL-100-Fe (e.g., a metal-organic framework, or MOF, material), which can readily absorb water when the relative humidity is above 20% and absorb very little water when relative humidity below 20%. This allows the first, second, and third desiccant to be easily regenerated with low humidity air from the carbon dioxide capture unit, without using external heating.

The carbon dioxide selective sorbent used in the carbon dioxide capture unit can be a diverse range of porous materials that are unfunctionalized, such as mesoporous silica, zeolites and metal-organic frameworks, or functionalized versions of these same materials with carbonate (e.g. K₂CO₃), amines, hydroxyl groups, or strong basic or acid ion-exchange type chemicals, ionic liquids, and the like.

For example, the amine-functionalized materials can include polymer-based inorganics like silica functionalized or coated with organic amines, or even MOFs with amines in their linkers. The types of zeolites can also be very broad and are not limited to acidic zeolites, because non-acidic zeolites can also adsorb carbon dioxide. These carbon dioxide sorbents can have different sensitivity to water and temperature. Physical carbon dioxide sorbents that have commonly lower heat of adsorption of carbon dioxide (e.g., less than 55 KJ/mol) have better carbon dioxide capture performance at lower temperature (e.g., below 0 degrees C. or below 0° C.) or higher carbon dioxide partial pressure and almost zero water vapor partial pressure. Chemical carbon dioxide sorbents that commonly display higher heats of adsorption of carbon dioxide (e.g., higher than 55 KJ/mol) have better performance at a medium range of temperature (e.g., 20 to 70° C.) or lower carbon dioxide partial pressure and at lower humidity (e.g., relative humidity or RH in the range of 10 to 30%). MSA carbon dioxide sorbents have optimal performance when the sorbent system is effective for carbon dioxide sorption, tolerant of low levels of water in that carbon dioxide sorption process, and then responsive to exposure to prescribed concentrations of water to effect the release of carbon dioxide.

In some embodiments, the water selective sorbent may be a liquid or a solid desiccant. The liquid desiccant can be, for example, triethylene glycol or lithium chloride aqueous solution. Solid desiccants can be, for example, silica gel, zeolite 3A or certain MOFs.

The frequency of switching between the first operating mode and the second operating mode of the apparatus may be selected based on the relative humidity and/or temperature of the air flow.

In some embodiments, the functional relationship between that switching frequency and air flow characteristics of humidity and temperature can be determined based on the effect of water/temperature on carbon dioxide sorption for given sorbents, or carbon dioxide capture mode (PSA, TSA, MSA), or both. For example, at a condition of an air flow temperature of 20° C. and a relative humidity of 20%, the carbon dioxide uptake rate is higher than that of a condition of 30° C. and a relative humidity of 30% for a quaternary ammonium resin sorbent used in MSA. The switching frequency can be inversely proportional to a carbon dioxide uptake rate to maximize the carbon dioxide uptake rate and carbon dioxide swing capacity per cycle. As another example, the switching frequency can also be set as proportional to the rate of a targeted relative humidity breakthrough in the second water extraction unit for PSA and TSA. The switching frequency can be combined with variation in the ambient air flow (e.g., fan speed or speed of other driving means/units) for further improvement of the carbon dioxide uptake rate.

The net result is that performance of the apparatus may be adjusted to result in a minimum or reduced energy usage or less energy burden during the carbon dioxide capture operation. Minimization or at least reduction of energy usage lowers the cost of carbon dioxide capture. A lower energy burden has a direct and favorable impact on the cost of net removal of carbon dioxide from the atmosphere.

In some embodiments, the first water extraction unit and the water release unit are combined into an enthalpy wheel. The enthalpy wheel is similar to a thermal wheel. The enthalpy wheel is a rotary component including the first water extraction unit and the water release unit that are exposed to different parts of the air flow depending on the rotation or position of the wheel. Accordingly, the first water extraction unit can be exposed to air entering the apparatus and the water release unit can be exposed to air that is output from the carbon dioxide capture unit, thereby implementing the first operating mode of the apparatus. Starting from the first operating mode of the apparatus, the first water extraction unit can be exposed to air that is output from the apparatus and the water release unit can be exposed to air entering the apparatus by rotation of the enthalpy wheel, thereby implementing the second operating mode of the apparatus.

In other words, the apparatus can be switched from the first to the second operating mode of the apparatus and vice versa by rotation of the enthalpy wheel or bypass, if needed. At high relative humidity ambient air conditions, the rotation speed of the enthalpy wheel can be increased to a range from 20 RPM (revolutions per minute) to 30 RPM to supply more stable conditioned air to the carbon dioxide capture unit. At low relative humidity conditions, the rotation speed of the enthalpy wheel can be reduced to a range from 5 RPM to 20 RPM. In some embodiments, at low relative humidity, the enthalpy wheel can be bypassed.

The use of the enthalpy wheel reduces the input of external heat to the apparatus, thus increasing the efficiency of the apparatus.

In some embodiments, the apparatus may be configured to control the temperature of the air flow provided to the carbon dioxide capture unit to a target temperature by the enthalpy wheel and an air-air or air-fluid heat exchanger. For example, when the ambient temperature is below 0° C., a heating device could be added before or after the enthalpy wheel to maintain the air flow temperature above 0° C., and therefore avoid frost formation in the second water extraction unit and carbon dioxide capture unit. This heating device could entail waste heat from separate industrial units.

The apparatus can be used as a standalone apparatus or in combination with another carbon dioxide capture apparatus, thus forming an assembly of carbon dioxide capture apparatuses. Each of the apparatuses corresponds to one of the apparatuses described herein. However, the apparatuses can be of different types.

In some embodiments, the apparatus may be configured such that the direction of the air flow being exhausted from the apparatus is substantially opposite to the direction of the air flow entering the apparatus. In this embodiment, the first water extraction unit and the water release unit of the apparatus are arranged on one enthalpy wheel such that the apparatus has a U-shaped configuration. That means that the inflow and the output of the apparatus are arranged on the same end of the apparatus with different flow directions of the inflowing and the output air flow.

In some embodiments, the apparatus is included in an assembly of apparatuses that includes at least two apparatuses as described herein (i.e., that includes at least one further apparatus as described herein). The two apparatuses have substantially opposite flow directions of their air flows. The first water extraction unit of the one apparatus and the water release unit of the other apparatus are arranged on one first enthalpy wheel. The first water extraction unit of the other apparatus and the water release unit of the one apparatus are arranged on one second enthalpy wheel that is different from the first enthalpy wheel. In some embodiments, the first enthalpy wheel is arranged at one end of the assembly and the second enthalpy wheel is arranged at an opposite end of the assembly.

In some embodiments, the apparatus may be configured to vary the degree of dehumidification (e.g., to adjust the relative humidity) of the air flow provided by the second water extraction unit based on the type of carbon dioxide capture. Additionally, or alternatively, the apparatus may be configured to vary the degree of dehumidification of the air flow provided by the second water extraction unit based on the temperature of the air flow. In some embodiments, the apparatus may be configured to vary the degree of dehumidification of the air flow provided by the second water extraction unit based on the starting level of relative humidity of the air flow.

In some embodiments, temperature, relative humidity, and/or molar ratio of water to carbon dioxide of the fluid stream input to the carbon dioxide capture unit is preconditioned to fall within certain predetermined ranges based on the type of carbon dioxide capture unit.

In some embodiments, the second water extraction unit provides more constant air flow conditions to the carbon dioxide capture unit than the first water extraction unit. For example, the second water extraction unit can be configured to provide a more constant relative humidity or water partial pressure of the air flow to the carbon dioxide capture unit than the first water extraction unit. For example, if the outdoor ambient air has a relative humidity variation from 30 to 70%, the air flow after the first water extraction unit will be varied to a relative humidity from 20% to 40%, and then the air flow provided by the second water extraction to feed the carbon dioxide sorbent beds will be only varied to a relative humidity from 10% to 20%. The second water extraction unit may also help increase the driving force to release the water back to air in the water release unit, which further reduces energy inputs to the carbon dioxide capture unit.

Additionally, or alternatively, the apparatus is configured to keep a molar ratio of water extracted from the air flow by the second water extraction unit to carbon dioxide captured by the carbon dioxide capture unit in a range below 30:1, optionally 3:1 to 15:1. This can minimize the energy usage of the carbon dioxide capture unit.

In some embodiments, the second water extraction unit may be configured to be regenerated in the second operating mode of the apparatus using heat. The heat may be provided to the second water extraction unit from a heat pump process. For example, a refrigeration cycle heat pump system could collect heat from ambient air, adsorption heat of the second water extraction unit, or downstream equipment, like a vacuum pump, a water condenser, and the like. This collected heat can be upgraded to a higher temperature in a range of 45° C. to 75° C. to be supplied as regeneration heat. Additionally, or alternatively, the apparatus may be configured to supply water vapor or water mist released from the second water extraction unit to the carbon dioxide capture unit to release carbon dioxide.

In some embodiments, the second water extraction unit may be configured to be regenerated in the second operating mode of the apparatus by a vacuum aided process. This can reduce the regeneration temperature of the second water extraction unit. It can also elevate the pressure of the water vapor supplied to the carbon dioxide capture unit to capture the carbon dioxide. For example, MIL-100-Fe water sorbents have a swing capacity about 0.6 gH₂O/g when they are regenerated at 60° C. and 50 mbar (vacuum), and when they are regenerated at 40° C. and 10 mbar (vacuum).

The apparatus may be configured to supply the water vapor released by the second water extraction unit in the second operating mode of the apparatus to the carbon dioxide capture unit during the second operating mode of the apparatus as one of a heating medium, a sweep gas, and moisture. This can ensure a fast release of carbon dioxide by the carbon dioxide capture unit. It can also reduce water usage per weight unit (e.g., per ton) of captured carbon dioxide by the carbon dioxide capture unit. For example, water vapor from the second water extraction unit during regeneration mode can be compressed to a range of 20 to 100 mbar via a vacuum booster pump, and the water vapor can be further conditioned to a targeted temperature range of 25° C. to 75° C. with a heat exchanger or de-superheated with a water mist spray, and then it can be supplied to the carbon dioxide capture unit as a working stream.

In some embodiments, the apparatus may be configured to control the temperature of the air flow provided to the carbon dioxide capture unit to the target temperature by using the second water extraction unit in combination with a heat pump or refrigeration cycle. Alternatively, the apparatus may be configured to control the temperature of the air flow provided to the carbon dioxide capture unit to the target temperature by using heat integration with a downstream process and/or external waste heat. For example, in summertime, when the ambient air is above 35° C., the second water extraction unit can be operated at lower temperatures, e.g., 25° C., with a refrigeration cycle. Accordingly, both the desiccant bed performance and the carbon dioxide sorbent performance can benefit. On the other hand, when the ambient air is below −5° C., the second water extraction unit can be operated at higher temperatures, e.g., 10° C., with a heat pump cycle, a heat exchanger, or an electrical heater. This can significantly reduce the temperature swing in the second water extraction unit and the carbon dioxide capture unit.

In some embodiments, the second water extraction unit may be configured to extract water from the air flow and to supply the air flow at a target humidity (e.g., at approximately 10% relative humidity for an MSA-DAC) to the carbon dioxide capture unit. The second water extraction unit, in combination with the first water extraction unit or the enthalpy wheel, is adjustable to a wide range of humidities depending on the type of the carbon dioxide capture unit, i.e., depending on whether the carbon dioxide capture unit is a MSA type unit, a PSA type unit, or a TSA type unit. The wide range of humidities is a range of a relative humidity of the air flow from 0 to 95 percent.

In some embodiments, a fluid stream may be a gaseous stream. In some embodiments, a fluid stream may be a liquid stream.

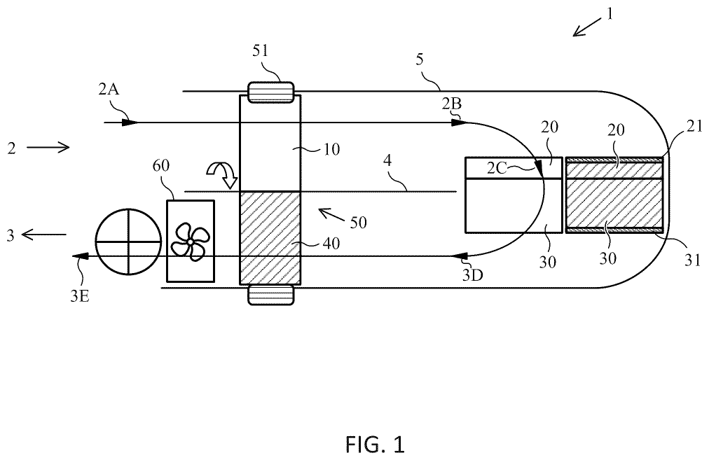

In FIG. 1, an apparatus 1 according to the present disclosure is shown that has a configuration in a U-shape that generally defines a curved flow path for the air flow. The apparatus 1 has a housing 5 defining an input (inflow) 2, an output (outflow) 3, and a flow path of the air flow between the input 2 and the output 3. The flow path is partitioned by a partition wall 4 into an inflow flow path communicating with the input 2 and an outflow flow path communicating with the output 3. Between the inflow flow path and the outflow flow path an intermediate flow path is provided in the housing 5.

In the input 2 or the inflow flow path, a (first) water extraction unit 10 is arranged in a first operating mode of the apparatus 1 where an ambient air stream 2A (e.g., a first fluid stream or incoming fluid stream) enters the first water extraction unit 10.

Downstream of the first water extraction unit 10 in the flow direction of the air flow in the first operating mode of the apparatus 1, a (second) water extraction unit 20 is arranged in the intermediate flow path. where a second fluid stream 2B enters the second water extraction unit 20.

Downstream of the second water extraction unit 20 and the first water extraction unit 10 in the flow direction of the air flow in the first operating mode of the apparatus 1, a carbon dioxide capture unit 30 is arranged in the intermediate flow path where a third fluid stream 2C enters the carbon dioxide capture unit 30.

The second water extraction unit 20 and the carbon dioxide capture unit 30 can also be arranged in the inflow flow path and/or in the outflow flow path of the apparatus 1. For example, a fourth fluid stream 3D may be arranged in the inflow flow path to allow the carbon capture unit to adsorb carbon dioxide from the third fluid stream 2C. In another example, during the second operating mode, the carbon dioxide capture unit 30, on exposure to water vapor, heat, pressure, or a combination thereof, adsorbed carbon dioxide may release to form a fifth fluid stream (not shown) comprising carbon dioxide and water. The fifth fluid stream may be arranged to be stored (e.g., stored underground, sequestered) as a product stream for further utilization (e.g., high purity water, compressed carbon dioxide).

The second water extraction unit 20 and the carbon dioxide capture unit 30 can be combined into one module. The module may have door seals 21 at the input (inflow) side of the module and door seals 31 at the output (outflow) side of the module.

In some embodiments, two (or even more) modules including a second water extraction unit 20 and a carbon dioxide capture unit 30 can be provided in parallel in the inflow path, the intermediate path, or the outflow path. The two modules can have door seals 21 at the input (inflow) side of the module and door seals 31 at the output (outflow) side of the modules. The door seals 21, 31 can be configured to be movable between the two modules (e.g., by sliding or rotating movement) so as to shut off one of the modules from the air flow in the housing 5.

Once a module is shut off, it can be regenerated, e.g., using a vacuum aided process. During the regeneration mode of the module, a water selective sorbent of the second water extraction unit 20 and a carbon dioxide sorbent of the carbon dioxide capture unit 30 can be regenerated.

Downstream of the carbon dioxide capture unit 30 in the flow direction of the air flow in the first operating mode of the apparatus 1, a water release unit 40 is arranged in the outflow flow path. A fourth fluid stream 3D may be arranged in the outflow flow path towards the water release unit 40.

The first water extraction unit 10 and the water release unit 40 can be combined in an enthalpy wheel 50. The enthalpy wheel 50 is rotatable (as shown in FIG. 1) so as to selectively expose the first water extraction unit 10 and the water release unit 40 to the air flow in the inflow flow path and the outflow flow path and vice versa. By rotation of the enthalpy wheel 50, the apparatus 1 can switch between the first operating mode of the apparatus 1 and the second operating mode of the apparatus 1.

The enthalpy wheel 50 can have louver doors 51 that are configured to control the amount of air in the housing 5 of the apparatus 1 (i.e., in the flow path).

The apparatus 1 also includes a driving unit 60 (fan or other driving means) for sucking ambient air into the apparatus 1 (for moving the air flow in the apparatus 1 between the input 2 and the output 3). In the presented embodiment, the driving unit 60 is arranged downstream of the water release unit 40 where a sixth fluid stream 3E may exit via the driving unit 60. However, the driving unit 60 can be arranged anywhere in the flow path of the air flow.

The operation of the apparatus 1 will be described in the following.

In the first operating mode, ambient air is sucked into the housing 5 of the apparatus 1 via the input 2 by the driving unit 60. The air flow (e.g., fresh air) enters the inflow flow path of the apparatus and flows through the first water extraction unit 10 (optionally through the enthalpy wheel 50). The first water extraction unit 10 extracts water (humidity) from the air flow. The air flow then flows to the second water extraction unit 20. Two modules including the second water extraction unit 20 and the carbon dioxide capture unit 30 are provided, as shown in FIG. 1. The air flow only flows through the module that is not shut off by the door seals 21. The module that is shut off by the door seals 21 undergoes regeneration with the release of the captured CO₂. The door seals 21 may move back and forth from the two modules in a cyclic manner such that one of the modules without the door seals 21 is absorbing CO₂ while the other module with the door seals 21 is desorbing CO₂. The second water extraction unit 20 extracts water (humidity) such that the relative humidity of the air flow is preconditioned for the DAC process in the carbon dioxide capture unit 30. The second water extraction unit 20 provides more stable (reliable) conditions (e.g., humidity or water partial pressure) of the air flow than the first water extraction unit 10. After being preconditioned by the second water extraction unit 20, the air flow flows through the carbon dioxide capture unit 30, in which carbon dioxide is captured from the air flow. Next, the air flow flows through the water release unit 40 (optionally through the enthalpy wheel 50). In the water release unit 40, a part of the water extracted from the air flow in the upstream part of the apparatus 1 is released back to the air flow. Next, the air flow is released (e.g., exhaust air) to the outside of the apparatus via the driving unit 60 (fan) and the output 3 of the apparatus 1.

Once the first water extraction unit 10 and the water release unit 40 need to be regenerated, the enthalpy wheel 50 is rotated to expose the first water extraction unit 10 to the outflow flow path so as to become the water release unit 40 and to expose the water release unit 40 to the inflow flow path so as to become the first water extraction unit 10. Accordingly, the apparatus 1 is in the second operating mode.

The U-shaped configuration of the apparatus I has the advantage that it can be made compact. Further, the apparatus can be used even when the apparatus has access to the ambient air only on one side, since the input and the output are on the same side/end of the apparatus.

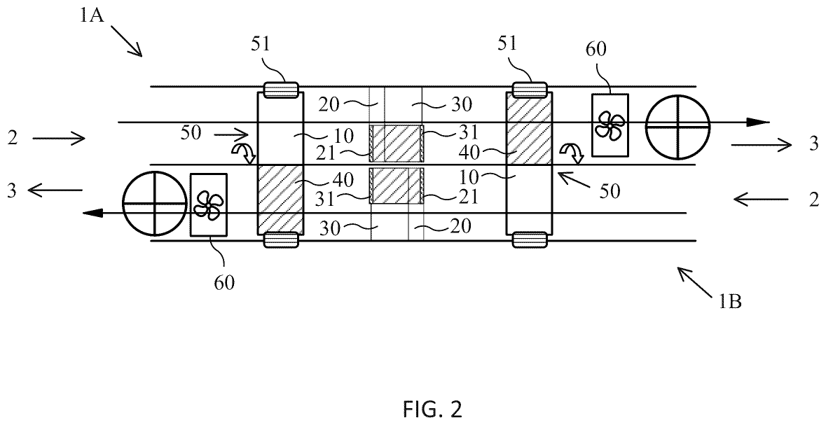

In FIG. 2, two apparatuses 1A, 1B according to the present disclosure are shown. Each of the apparatuses 1A, 1B corresponds to that as shown in FIG. 1 and described above, except that it has a generally linear configuration instead of the U-shaped configuration. Further, the apparatuses 1A, 1B are arranged as an assembly in a counterflow manner (i.e., the two apparatuses, 1A, 1B are 180° rotational reflections of each other). In other words, the inputs 2 and the outputs 3 of the apparatuses 1A, 1B (and the sequence of the units in the apparatuses) are mutually switched. The direction of the airflow in the upper apparatus 1A is from left to right in FIG. 2. The direction of the airflow in the lower apparatus 1B is from right to left in FIG. 2, i.e., is opposite to the flow direction of the upper apparatus 1A.

The operation of each of the apparatuses corresponds to that as previously described referring to FIG. 1. In contrast to the apparatus of FIG. 1, in the apparatuses 1A, 1B of FIG. 2, the first water extraction unit 10 of each apparatus (e.g., 1A or 1B) is coupled to the water release unit 40 of the other apparatus (e.g., 1B or 1A) by means of an enthalpy wheel 50.

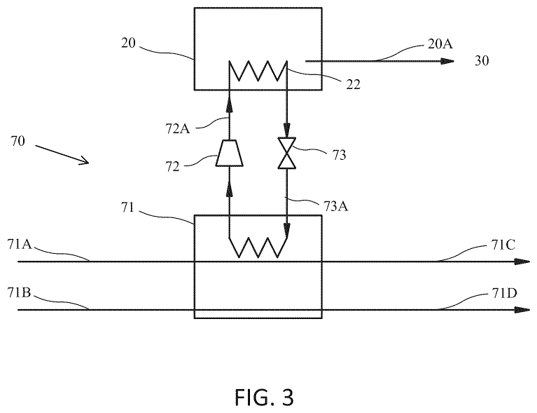

FIG. 3 shows the regeneration of the second water extraction unit 20 in the second operating mode of the apparatus 1. The regeneration process utilizes elevated temperature heat from a heat pump process of a refrigeration cycle heat pump system 70. In the exemplary embodiment of FIG. 3, the heat pump system 70 includes a heat exchanger 71 (e.g., heat sources, QL), a compressor 72, and an expansion valve 73. The second water extraction unit 20 additionally includes another heat exchanger 22 (e.g., a heat sink, QH). The other heat exchanger 22 can also be regarded as part of the refrigeration cycle of the heat pump system 70.

The heat exchanger 71 receives a hot air flow 71A and/or a hot process fluid flow 71B that transfers heat to a refrigerant of the heat pump system 70. Generally, the heat exchanger can collect heat from ambient air, adsorption heat of the second water extraction unit 20, or downstream equipment, like a vacuum pump, a water condenser, and the like. After having transferred the heat to the refrigerant, the air flow and/or the process fluid flow exit the heat exchanger 71 as a cold air flow 71C and a cold process fluid flow 71D, respectively. The refrigerant that has received heat from the hot air flow 71A and/or the hot process fluid flow 71B flows out of the heat exchanger 71 towards the compressor 72 as a hot refrigerant 72A and is compressed by the compressor 72. Next, the compressed hot refrigerant flows towards the second water extraction unit 20 and enters the other heat exchanger 22, the compressed hot refrigerant having a temperature in a range of 45 to 75° C. In the other heat exchanger 22, the compressed hot refrigerant transfers heat to the water extracted by the second water extraction unit 20 from the air flow of ambient air in the first operating mode of the apparatus 1 and flows out of the other heat exchanger 22 as a cold refrigerant 73A towards the expansion valve 73. By the heat received from the compressed hot refrigerant, the second water extraction unit 20 is regenerated by releasing the water that has been extracted from the air flow through the apparatus 1 as water vapor or water mist from the second water selective sorbent of the second desiccant bed.

In some embodiments, the released water vapor 20A or water mist flows to a downstream condenser and/or to the carbon dioxide capture unit 30 for desorption of the carbon dioxide captured during the first operating mode of the apparatus 1. The carbon dioxide capture unit 30 may be an MSA type unit in the present embodiment. In the expansion valve 73, the cold refrigerant is expanded (decompressed) and flows back towards the heat exchanger 71, where the refrigeration cycle starts again. As a result, the second water extraction unit 20 can be regenerated efficiently.

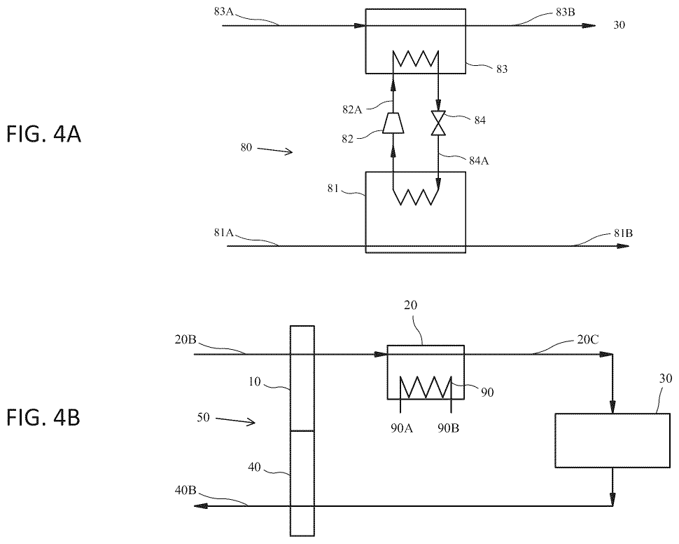

FIGS. 4A and 4B show two examples of a structure of the carbon dioxide capture apparatus 1 that are configured to supply heat to the air flow of ambient air during low temperature ambient air conditions (for example, when the ambient air temperature is below −5° C.), such as during wintertime. The examples are not exclusive and can be combined to provide a larger amount of heat to the air flow than each of the examples per se.

FIG. 4A shows an example in which a heat pump cycle 80 is used to pre-heat the air flow before entering the carbon dioxide capture unit 30 to make the DAC more efficient. In the exemplary embodiment of FIG. 4A, the heat pump cycle 80 includes a heat exchanger 81 (e.g., heat sources, QL), a compressor 82, another air heater or heat exchanger 83 (air heater or a heat sink, QH), and an expansion valve 84. The air heater or heat exchanger 83 can be part of/integrated with the second water extraction unit 20 or can be provided separately from the second water extraction unit 20 in the apparatus 1.

The heat exchanger 81 receives a hot process fluid flow 81A that transfers heat to a refrigerant of the heat pump cycle 80. After having transferred the heat to the refrigerant, the process fluid flow flows out of the heat exchanger 81 as a cold process fluid flow 81B. The refrigerant that has received heat from the hot process fluid flow flows out of the heat exchanger 81 towards the compressor 82 as a hot refrigerant 82A and is compressed by the compressor 82. Next, the compressed hot refrigerant flows towards the air heater 82. In the air heater 82, the compressed hot refrigerant transfers heat to the air flow and flows out of the air heater 82 as a cold refrigerant 84A towards the expansion valve 84. The cold air flow 83A that has received heat from the refrigerant flows out of the air heater 83 towards the carbon dioxide capture unit 30 as a hot air flow 83B. If the air heater 83 is provided as a separate component, the hot air flow flows towards the second water extraction unit 20 that is downstream of the air heater 83 before entering the carbon dioxide capture unit 30. In the expansion valve 84, the cold refrigerant is expanded (decompressed) and flows back towards the heat exchanger 81, where the refrigeration cycle starts again. As a result, the second water extraction unit 20 can be operated at higher temperatures, e.g., ₁₀° C., as compared to the temperature of the ambient air that is, e.g., below −₅° C. Accordingly, the DAC process in the carbon dioxide capture unit 30 can be made more efficient.

FIG. 4B shows an example, in which a heat exchanger 90 (air heater) is used to pre-heat the air flow before entering the carbon dioxide capture unit 30 to make the DAC more efficient. In the exemplary embodiment of FIG. 4B, the air heater 90 is integrated into the second water extraction unit 20. However, the air heater 90 can be provided separately from the second water extraction unit 20 of apparatus 1.

In the exemplary embodiment of FIG. 4B, the air heater 90 is arranged downstream of the enthalpy wheel 50 and upstream of the carbon dioxide capture unit 30 and is integrally built into the second water extraction unit 20.

In the exemplary embodiment of FIG. 4B, the air heater 90 (or the second water extraction unit 20) receives a hot process fluid flow 90A that transfers heat directly to the air flow of the apparatus 1. After having transferred the heat to the air flow, the process fluid flow flows out of the air heater 90 as a cold process fluid flow 90B. The cold air flow 20B that has received heat from the hot process fluid flows out of the air heater 90 (or the second water extraction unit 20) towards the carbon dioxide capture unit 30 as a hot air flow 20C. If the air heater 90 is provided as a separate component, the hot air flow flows towards the second water extraction unit 20 that is downstream of the air heater 90 before entering the carbon dioxide capture unit 30. The hot air flow exiting the carbon dioxide capture unit 30 may further be exposed to the water release unit 40 and release the air flow or exhaust air 40B outside the apparatus. As a result, the second water extraction unit 20 can be operated at higher temperatures, e.g., ₁₀° C., as compared to the temperature of the ambient air that is, e.g., below −₅° C. Accordingly, the DAC process in the carbon dioxide capture unit 30 can be made more efficient.

The air heater 90 can also be an electrical air heater directly transferring heat to the air flow.

The embodiments of FIGS. 3, 4A and 4B can be combined with each other and/or with the embodiments of the apparatus 1 and apparatuses 1A, 1B of FIGS. 1 and 2, respectively.

### Logic Control System

The logic control system will be described with respect to an MSA-CO₂ unit. However, it is equally applicable to TSA-CO₂ and PSA-CO₂ units.

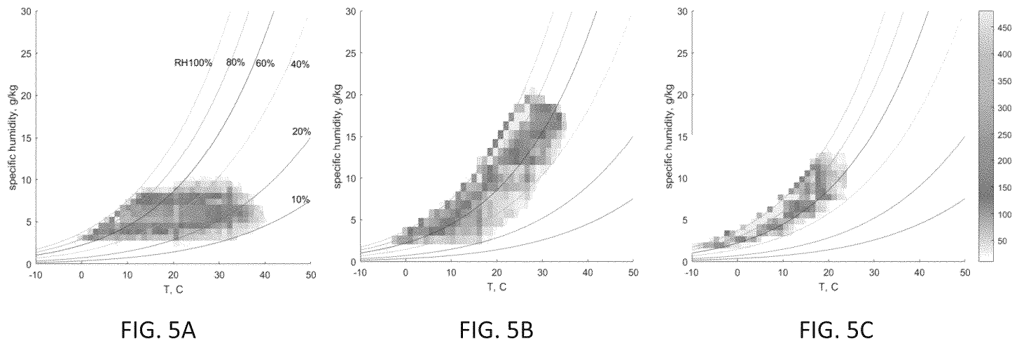

FIGS. 5A-5C shows the measured specific humidity and temperature variations, measured on an hourly basis, over the course of one year (e.g., 8760 hours per year) for three locations: Bakersfield, California (20° C., Relative Humidity 45%); Geismar, Louisiana (20° C., Relative Humidity 74%); and Stenlille, Denmark (9° C., Relative Humidity 85%). As shown in FIGS. 5A-5C, the temperature and humidity profiles differ significantly among these three locations. In addition, each location also displays significant variation within an annual time period. Thus, without preconditioning, properties of the feed air to an MSA-CO₂ unit would vary significantly based on both location and diurnal and seasonal cycles. In order to adjust these properties to maximize CO₂ capture efficiency, a logic control system that makes the adjustments in “real-time” (such as on a daily, hourly, minute-by-minute, or second-by-second basis) would be highly beneficial.

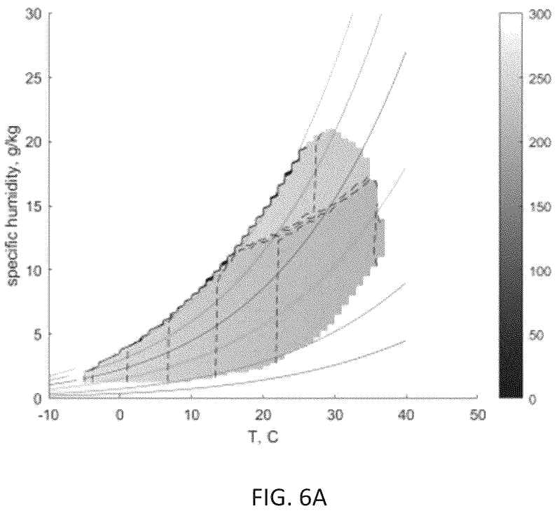

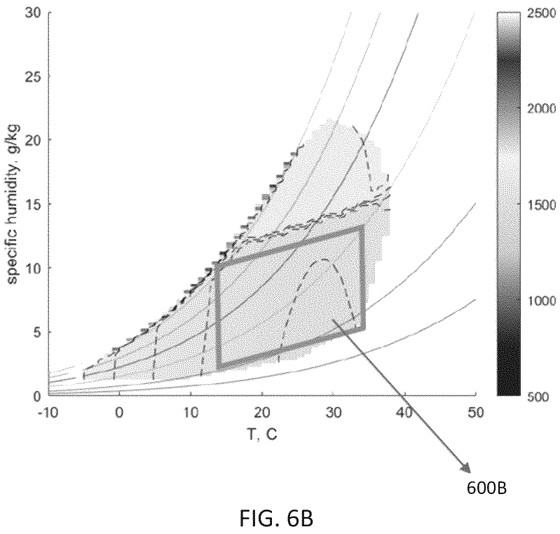

FIG. 6A illustrates a calculated levelized cost of CO₂ capture on a per ton CO₂ captured basis (LCOC in $ per ton of CO₂) for an MSA-DAC operation in Geismar, Louisiana. For points with specific humidities and temperatures above approximately 12 g/kg and 17° C., respectively, the LCOC rises significantly. As shown in FIG. 5B, in Geismar, the conditions extend into this unfavorable region during a significant number of hours of the year. The logic control system described herein, by optimizing the combination of humidity and temperature of feed air on a real-time basis to a target range, could substantially reduce the LCOC of an MSA-DAC.

In some embodiments, the logic control system could minimize the LCOC of an MSA-DAC operation on a real-time basis. In some circumstances, the real-time direct calculation of LCOC may be difficult or impractical. For this reason, FIG. 6B shows the calculated energy consumption on a kilowatt-hour per ton of CO₂ captured basis for the same MSA-DAC operation as in FIG. 6A. The energy consumption profile is very similar to the LCOC profile: notably, the energy consumption also increases significantly for points with specific humidity and temperature above about 12 g/kg and about 17° Celsius, respectively. Thus, the parameter to be adjusted by the logic control system is a minimization of MSA-DAC energy consumption on a real-time basis.

FIG. 6B also shows an optimal zone 600B or target range of specific humidity and temperature conditions entering the CO₂ capture unit, leading to efficient operation of MSA-DAC in Geismar.

In some embodiments, the logic control system described herein could adjust the combination of temperature and moisture content of the fluid stream provided to the MSA-CO₂ unit to be within the target zone. In some embodiments, the logic control system could adjust the relative humidity of the ambient air to a target range of between about 10% and about 50%. In some embodiments, the target range of the relative humidity may be 5% or less. In some embodiments, the target range of relative humidity is between about 4 g/kg dry air and about 12 g/kg dry air.

In some embodiments, the logic control system could adjust the temperature of the ambient air to a target range of between about 10° C. and about 30° C.

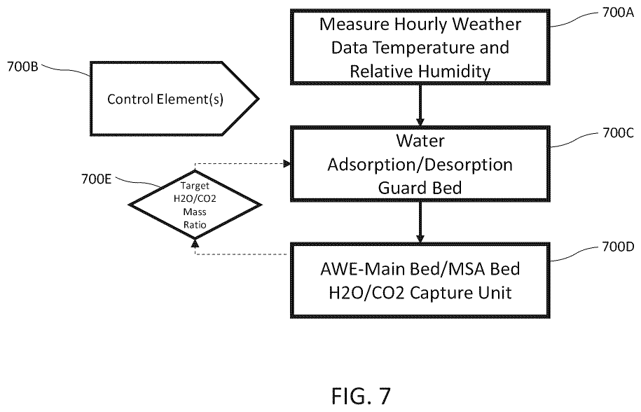

The logic control system follows a simplified schematic of an MSA-DAC preconditioner, as illustrated in FIG. 7. As shown in FIG. 7, weather data is first measured, including the temperature and relative humidity of ambient air entering the MSA-DAC apparatus. The measurement of the weather data 700A is hourly, or optionally is on a different frequency, such as every week, every day, every minute, or every second. The fluid stream is subject to one or more control elements 700B, such as an air flow rate, a pressure drop, or a fan speed or efficiency. Optionally, one or more of these control elements 700B is applied to the fluid stream before it enters a water adsorption/desorption bed 700C, such as before entering a first water extraction unit. Alternatively, one or more of the control elements 700B is applied to the fluid stream at any point at or before reaching the MSA-CO₂ unit. The first water extraction unit decreases the humidity of the air, such as by using a water adsorption/desorption bed comprising a desiccant sorbent, or by an enthalpy wheel comprising a desiccant sorbent.

In some embodiments, a control element of the logic control system could be configured in the form of a switching frequency between adsorption and regeneration modes of the first water extraction unit. This switching frequency may be used to adjust the humidity of the air flow to a target range. Generally, a higher switching frequency will lead to a higher level of dehumidification and will be used when the ambient humidity is high.

In some embodiments, the preconditioner includes an enthalpy wheel. When an enthalpy wheel is present, the switching frequency control element may include the rotational speed of the enthalpy wheel. Generally, during periods of high ambient air moisture content, the rotational speed of the enthalpy wheel can be increased, while the rotational speed can be decreased during periods of low moisture content, or the ambient air can be made to by-pass the enthalpy wheel entirely.

In some embodiments, the air flow rate is adjusted together with the rotational speed of the enthalpy wheel. For example, when the ambient air relative humidity is inside of the target zone (e.g. 25° C., RH30), the air flow rate may be about 100,000 cfm and the rotational speed of the enthalpy wheel may be about 6 revolutions per minute (RPM). When the ambient air relative humidity is outside of the target zone (e.g. 25° C., RH80), the air flow rate may be reduced to about 80,000 cfm, and the rotational speed of the enthalpy wheel may be increased up to 30 RPM.

In some embodiments, the logic control system could control the temperature of the fluid stream provided to the MSA-CO₂ unit. Adjustments in the fluid stream's temperature can be achieved in any suitable manner, including any method described herein. In some embodiments, the temperature may be controlled by a heat pump or a refrigeration cycle, an air heater, or an air conditioning (A/C) cooling system. In some embodiments, an air-air heat exchanger is used.

In some embodiments, the temperature of the fluid stream may be adjusted by exchanging heat between an endothermic process, such as H₂O desorption in a water release unit 40, and an exothermic process, such as H₂O adsorption in a first water extraction unit 10 (and/or the second water extraction unit 20).

In some embodiments, the air temperature may be controlled by integration of heat with downstream processes and/or external waste heat.

In some embodiments, the humidity and/or temperature of ambient air may be adjusted to achieve a target mole ratio of water harvested from the air flow to total water consumed in CO₂ desorption onto the moisture swing sorbent, additionally or alternatively to achieving a target zone of temperature and/or relative humidity. As illustrated in FIG. 7, the target H₂O/CO₂ mass ratio 700E (e.g., target mole or molar ratio) is adjusted.

In some embodiments, at high humidity conditions, the target H₂O/CO₂ mass ratio may be adjusted to about 8:1, while at low humidity conditions, this mole ratio may be adjusted to about 0:1, at which point MSA-DAC may be water neutral or even slightly water consumptive. The target mole ratio may vary from about 40:1 to about 0:1 depending on conditions.

As illustrated in FIG. 7, the humidity and/or temperature of ambient air is adjusted to achieve a target molar ratio of H₂O to CO₂ in the fluid stream provided to the AWE-main bed/MSA bed or H₂O/CO₂ capture unit 700D (e.g., at the MSA-CO₂ unit), additionally or alternatively to achieving a target zone of temperature and/or relative humidity. This molar ratio may be adjusted to a range of between about 1:1 to about 60:1, optionally to a range of between about 5:1 to about 30:1.

The logic control system could include at least one controller and at least one control element in communication with a fluid stream and the controller. The controller can be configured to adjust to a pre-defined target range or a pre-determined range of at least one property of the fluid stream. In some embodiments, the pre-defined target range or the pre-determined range is determined based upon energy consumption or levelized cost of capture of CO₂ by MSA-DAC. In some embodiments, the logic control system controls a temperature, a water content, or combination thereof of a second fluid stream, a third fluid stream, or both within pre-determined ranges in real time.

The controller could be a general computer, comprising a processor, memory, and optionally a storage drive. The controller may further comprise computer-readable instructions to adjust the pre-defined target ranges or pre-determined ranges via a control cycle. The control cycle may receive at least one measurement of the temperature, water content, or combination thereof of the ambient air stream, second fluid stream, third fluid stream, or combination thereof from at least one sensor in communication with the ambient air stream, second fluid stream, third fluid stream, or combination thereof. The control cycle may also determine, via the controller, whether the at least one measurement is within the pre-determined range. The control cycle may further transmit at least one control signal to at least one control element, wherein the control element is configured to actuate upon receiving the control signal to adjust the temperature, water content, or combination thereof of the ambient air stream, second fluid stream, third fluid stream, or combination thereof.

The controller can be configured to be in electrical communication with one or more of a heat pump, refrigeration element, a component that integrates heat generated by the MSA-DAC apparatus and external waste heat, a component of the MSA-DAC apparatus that sets a switching frequency between a sorption mode and a regeneration mode of the MSA-DAC apparatus, an enthalpy wheel, a component that sets a rotation speed of the enthalpy wheel, a fan or other component that sets an air flow rate of the fluid stream, a component that sets a mass ratio of a water harvest from the fluid stream to a total water consumed in CO₂ desorption from an MSA sorbent, and a component that sets a molar ratio of H₂O and CO₂ in the fluid stream.

The controller can be configured to communicate with a heat pump or refrigeration element, wherein the heat pump or refrigeration element may adjust the temperature of the fluid stream.

The controller can be configured to communicate with a component that integrates heat generated by the MSA-DAC apparatus and an external waste heat. In some embodiments, this component may adjust the temperature of the fluid stream.

The controller can be configured to communicate with a component that sets a switching frequency between a sorption mode and a regeneration mode of the MSA-DAC apparatus. In some embodiments, this component can adjust the humidity and/or temperature of the fluid stream.

The controller can be configured to communicate with an enthalpy wheel. The controller can be configured to control the enthalpy wheel, such as controlling its rotational speed, to adjust the fluid stream's humidity.

The controller can be configured to communicate with a fan or other component that sets an air flow rate of the fluid stream. The fan or other component can adjust the humidity and/or the temperature of the fluid stream entering the MSA-CO₂ unit because of interactions between the fluid stream and components of the preconditioner. In some embodiments, such interactions are dependent on the air flow rate (such as a time duration of contact between the fluid stream and a sorbent bed, for example).

The controller can be configured to communicate with a component that sets a mass ratio of a water harvest from the fluid stream to a total water consumed in CO₂ desorption from an MSA sorbent. The component that sets the mass ratio may be any other control element(s) that is configured to communicate with the controller, such as any of the control elements described herein. For example, the switching frequency between sorption and generation mode may affect the mass ratio, or, for example, a combination of switching frequency and a heat pump may together affect the mass ratio.

The controller can be configured to communicate with a component that sets a molar ratio of H₂O and CO₂ in the fluid stream. The component that sets the molar may be any other control element(s) that is also in electrical communication with the controller, such as any of the control elements described herein. For example, the switching frequency between sorption and generation mode may affect the molar ratio, or, for example, a combination of switching frequency and a heat pump may together affect the molar ratio.

The controller could also communicate with one or more sensors. In some embodiments, the sensors could provide one or more signals to the controller. In some embodiments, the controller could actuate the control elements to adjust the various properties of the fluid stream to the pre-defined target ranges or pre-determined ranges. These properties include temperature, relative humidity, and air flow rate.

### EXAMPLES

### Example 1: Annual Temperature and Humidity Variations at Three Locations

### Methods

FIGS. 5A-5C shows three site weather conditions, hourly absolute humidity versus ambient air temperature (2012-2022) with the frequency of occurrence indicated by the color coding, the high frequency events being shown in yellow.

### Results

Both temperature and humidity profiles display wide variations across different sites and within a single site over the course of a one-year time period.

### Example 2: Calculation of LCOC and Energy Cost of Example MSA-DAC Operation Geismar, Louisiana

### Computational Methods

For FIG. 6A, LCOC cost was calculated from annualized CAPEX and OPEX with constant adsorption-desorption cycle time, feed air mass flow rate and sorbent bed size. Ambient air at each hourly weather condition was fed to an MSA-DAC process model, which enabled calculation of the energy consumption and CO₂ productivity, both on an hourly basis. The unit electricity cost was set as 0.05 $/kwh, and the baseline CAPEX as 2000 $/TPA CO₂, with an annualized capex cost factor of 10%. Extra process equipment costs and associated energy costs were added to achieve a representative model for normal MSA-DAC operations.

FIG. 6B shows the results of the following process: the energy cost estimate used the same approach as above, and covers energy consumption for air movement, vacuum pumps, and heat pumps, the majority energy consumption sources for MSA-DAC operation.

### Results

LCOC variation shows an unfavorable region at combination of temperature above about 17° C. and specific humidity above about 12 g/kg dry air.

Energy cost calculation parallels the approach for LCOC showing nearly identical favorable and unfavorable regions.

### Example 3: Logic Control System for Preconditioning of a Fluid Stream Using MIL-100-Fe Sorbent in a Water Extraction Unit and a Quaternary Ammonium Polymer in an MSA-CO₂ Unit

### Workflow for Logical Control System

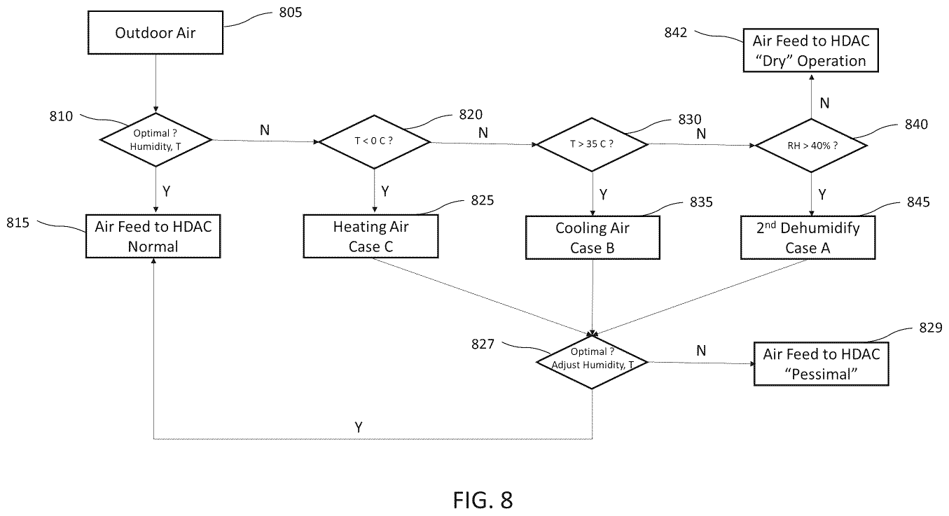

FIG. 8 illustrates an example schematic workflow for the logical control system for the MSA-DAC preconditioner. In FIG. 8, the properties of ambient outdoor air 805 are first determined. The humidity of the fluid stream is checked to see if it is in the optimal range 810. If yes, then the fluid stream is sent to the MSA-CO₂ unit according to “HDAC Normal” operation 815 (as defined below). If no, then the temperature of the fluid stream is checked to see if it is below 0° C. 820. If yes, then the fluid stream is sent for heating (“Case C”) 825. If no, then the temperature of the fluid stream is checked to see if it is above 35° C. 830. If yes, then the fluid stream is sent for cooling (“Case B”) 835. If no, then the relative humidity of the fluid stream is checked to see if it is above 40% 840. If no, then the fluid stream is sent to the MSA-CO₂ unit according to “HDAC Dry” operation 842 (as defined below). If yes, then the fluid stream is sent for dehumidification (“Case A”) 845.

Following the operations of either Case A, B, or C, the fluid stream is then checked again to see if the temperature and/or the relative humidity have been successfully adjusted to the target zone 827. If no, then the relative humidity is sent to be either humidified or dehumidified. Following the humidity adjustment, the temperature and relative humidity are checked again to see if they are in the target zone 827. If no, then the fluid stream is sent to the MSA-CO₂ unit according to “HDAC Pessimal” operation 829 (as defined below). If yes, then the fluid stream is sent to the MSA-CO₂ unit according to “HDAC Normal” operation 815.

“HDAC Normal” operation means HDAC runs at the full capacity with designed air feed rate, and standard cycle time as designed.

“HDAC Dry” operation means HDAC runs at the full capacity with designed air feed rate, and standard cycle time as designed, but water is recycled to regenerate MSA bed.

“HDAC Pessimal” operation means the HDAC runs at reduced capacity and lower air feed rate with cycle time that can be adjusted accordingly.

### Psychrometric Chart Showing Cases A, B and C

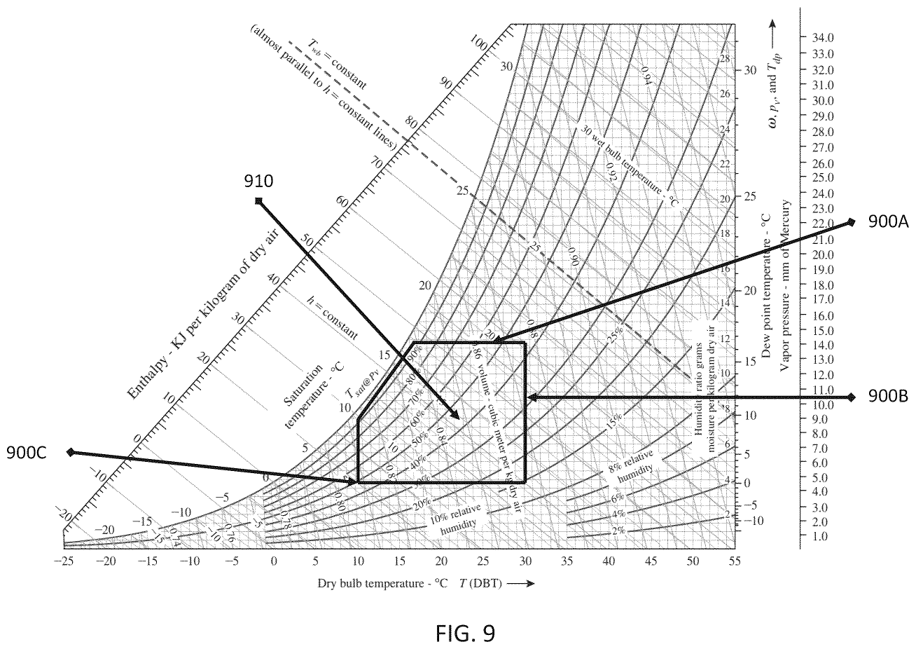

FIG. 9 illustrates an example psychrometric chart for the MSA-DAC operation using a MIL-100-Fe sorbent for water extraction and a quaternary ammonium polymer for MSA-CO₂ adsorption/desorption. For illustrative purposes in the present example, the “optimal zone” is shown as the region bounded by temperatures between 10° C. and 30° C. and humidity ratio between 4 g/kg dry air and 12 g/kg dry air. Other configurations and other values can be used keeping in mind a goal of decreasing the LCOC and/or energy cost.

### Results

As a preliminary matter, when the ambient air temperature and relative humidity are already within the target zone, the fluid stream is provided to the MSA-CO₂ unit without preconditioning according to “HDAC Normal” operation. However, ambient temperature and/or humidity conditions at many times may be outside of the optimal zone 910. Three example cases are provided below as illustrative examples.

Case A 900A. As illustrated in FIG. 9, the ambient air temperature was 35° Celsius and the humidity ratio was 20 g moisture per kg dry air (“g/kg”). The air was dehumidified using the enthalpy wheel. Next, the air was cooled using an A/C system to provide the air in the target zone, having a temperature of 25° Celsius and relative humidity of 10 g/kg. The fluid stream was then sent to the MSA-CO₂ unit according to “HDAC Normal” operation.

Case B 900B. As illustrated in FIG. 9, the ambient air temperature was 40° Celsius and the relative humidity was 10 g/kg. The fluid stream was cooled using an A/C system in combination with an air-air heat exchanger. Following cooling, the fluid stream was in the optimal zone 910 with temperature of 30° Celsius and relative humidity of 10 g/kg and was sent to the MSA-CO₂ unit according to “HDAC Normal” operation.

Case C 900C. As illustrated in FIG. 9, the ambient air temperature was −5° Celsius and the relative humidity was 1 g/kg. The air was first heated using an air heater. Then, the humidity was adjusted by using a humidification technique (direct injection steam, or hot water mist by ultrasonic). Following humidification, the fluid stream was in the optimal zone 910 with temperature of 10° Celsius and relative humidity of 4 g/kg and was sent to the MSA-CO₂ unit according to “HDAC Normal” operation.

### Example 4: Adjustment of the Relative Humidity of a Fluid Stream to a Target Mass Ratio of H₂O Harvested From the Fluid Stream to Total Water Consumed in CO₂ Desorption

### Computational Methods

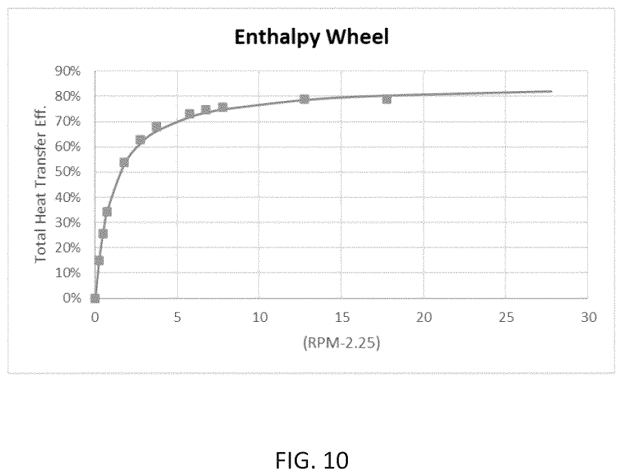

Heat and mass balance (HMB) modeling was performed using as input measured annual weather data taken from three locations: Bakersfield, California; Geismar, Louisiana; and Stenlille, Denmark. The operation of the enthalpy wheel was modeled with its total heat exchange efficiency for controlling the relative humidity of the air feed to AWE-main and further to MSA-DAC sorbent bed, as shown in FIG. 10.

### Results

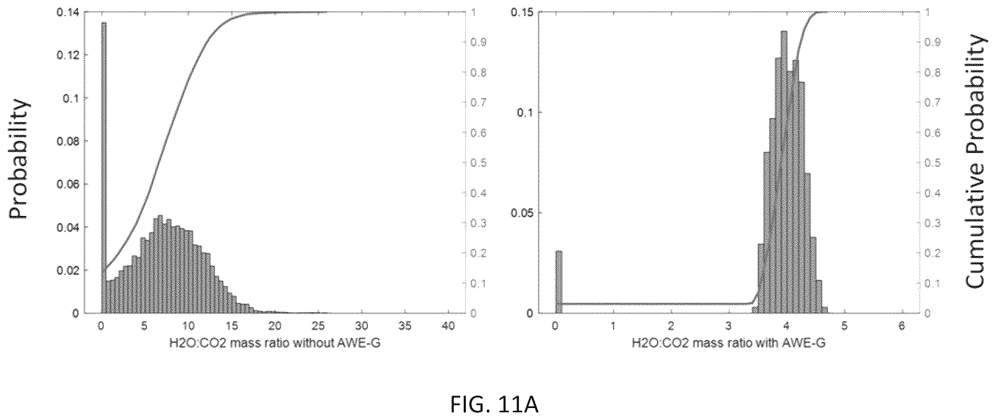

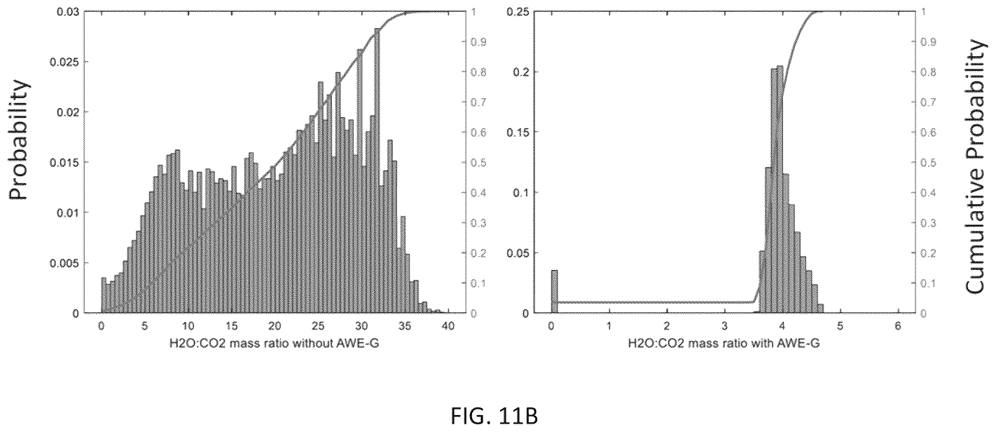

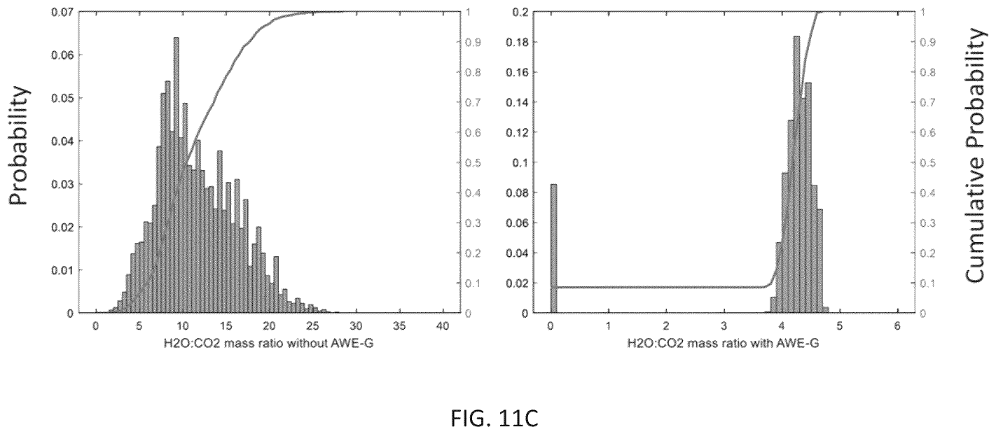

FIGS. 11A-11C show the distribution of the mass ratios of H₂O harvested from the fluid stream to water consumed in CO₂ desorption for the three locations (FIG. 11A: Bakersfield, California, FIG. 11B: Geismar, Louisiana, FIG. 11C: Stenlille, Denmark). The three locations have the following temperature (C) and relative humidity (RH): Bakersfield, California (20° C., Relative Humidity 45%); Geismar, Louisiana (20° C., Relative Humidity 74%); and Stenlille, Denmark (9° C., Relative Humidity 85%). By using the enthalpy wheel, a mass ratio distribution was achieved with a narrow distribution away from the target value compared to the unadjusted mass ratio distribution.

### Example 5: Controlling Heat Transfer Efficiency Using an Enthalpy Wheel in the First Water Extraction Unit

### Computational Methods

An MSA-DAC process model was used to evaluate the water capture requirement for a case without AWE-G bed, and with AWE-G bed (enthalpy wheel). The enthalpy wheel performance can be adjusted according to rotational speed as shown in FIG. 10. At relative dry weather conditions, such as 20° C. and RH30, the enthalpy wheel total heat exchange efficiency can be controlled at 50% with ˜5 RPM rotational speed, so a target water-CO₂ mole ratio as 8 to 12 to 1 can be achieved.

### Results

FIGS. 11A-11C shows the results on three sites (FIG. 11A: Bakersfield, California, FIG. 11B: Geismar, Louisiana, FIG. 11C: Stenlille, Denmark), with AWE-G case (right) versus without AWE-G case (left). Based on the results, the AWE-G will reduce the H₂O:CO₂ mole ratio, reduce the AWE-main beds water capture requirement, and thus the energy usage.

What is claimed is:

1. An apparatus comprising:
a first water extraction unit configured to receive an ambient air stream comprising water and carbon dioxide and to adsorb water from the ambient air stream at atmospheric pressure to form a second fluid stream having a water content less than the water content of the ambient air stream;
a process unit comprising a second water extraction unit downstream of the first water extraction unit and a carbon capture unit downstream of the second water extraction unit, wherein the process unit is capable of reversibly operating in (a) capture mode to adsorb water and carbon dioxide from an incoming fluid stream and (b) regeneration mode to release adsorbed water and carbon dioxide, and wherein the process unit is configured such that, during capture mode:
the second water extraction unit receives the second fluid stream from the first water extraction unit and adsorbs water from the second fluid stream to form a third fluid stream having a water content less than the water content of the second fluid stream;
the carbon capture unit receives the third fluid stream and adsorbs carbon dioxide from the third fluid stream to form a fourth fluid stream having a carbon dioxide content that is less than the carbon dioxide content of the third fluid stream; and
during release mode of the carbon capture unit, on exposure to water vapor, heat, pressure, or a combination thereof, releases adsorbed carbon dioxide to form a fifth fluid stream comprising carbon dioxide and water; and
a water release unit downstream of the process unit configured to receive the fourth fluid stream from the carbon capture unit and (a) combine the fourth fluid stream with adsorbed water from the first water extraction unit to form a sixth fluid stream and (b) release the sixth fluid stream back into atmosphere.

2. The apparatus of claim 1, wherein the process unit is configured to switch between capture mode and release mode at a prescribed operational frequency.

3. The apparatus of claim 1, wherein the first water extraction unit and the water release unit are configured to form an enthalpy wheel.

4. The apparatus of claim 1, wherein at least one of the first water extraction unit, the second water extraction unit, and the water release unit comprises a desiccant bed comprising a moisture sorbent.

5. The apparatus of claim 1, wherein at least one of the first water extraction unit, the second water extraction unit, and the water release unit comprises a desiccant bed comprising a bifunctional sorbent.

6. The apparatus of claim 1, wherein the carbon capture unit comprises a moisture swing adsorption unit.

7. The apparatus of claim 1, wherein the carbon capture unit comprises a pressure swing adsorption unit.

8. The apparatus of claim 1, wherein the carbon capture unit comprises a temperature swing adsorption unit.

9. The apparatus of claim 1, wherein the carbon capture unit comprises a sorbent bed comprising a carbon dioxide sorbent.

10. The apparatus of claim 1, wherein the carbon capture unit comprises a sorbent bed comprising a bifunctional sorbent.

11. The apparatus of claim 1, wherein the apparatus is configured to control temperature, water content, or combination thereof of the second fluid stream, third fluid stream, or both within pre-determined ranges.

12. The apparatus of claim 1, further comprising a logic control system for controlling temperature, water content, or combination thereof of the second fluid stream, third fluid stream, or both within pre-determined ranges in real time, the logic control system comprising:
a controller; and
at least one control element in communication with the ambient air stream, second fluid stream, third fluid stream, or combination thereof,
wherein the controller is configured to adjust the temperature, the water content, or combination thereof of the second fluid stream, third fluid stream, or both to pre-determined ranges based on a cost to capture carbon dioxide on a net removal basis.

13. The logic control system of claim 12, wherein the controller comprises a processor and a memory comprising computer-readable instructions to adjust the pre-determined ranges via a control cycle, the control cycle comprising:
receiving at least one measurement of the temperature, the water content, or combination thereof of the ambient air stream, second fluid stream, third fluid stream, or combination thereof from at least one sensor in communication with the ambient air stream, second fluid stream, third fluid stream, or combination thereof;
determining, by the controller, whether the at least one measurement is within the pre-determined ranges; and
transmitting at least one control signal to at least one control element, wherein the at least one control element is configured to actuate upon receiving the at least one control signal to adjust the temperature, the water content, or combination thereof of the ambient air stream, second fluid stream, third fluid stream, or combination thereof.

14. A system comprising a first apparatus according to claim 1 and a second apparatus according to claim 1,
wherein the process unit of the first apparatus operates in capture mode when the process unit of the second apparatus operates in release mode, and the process unit of the first apparatus operates in release mode when the process unit of the second apparatus operates in capture mode, and
wherein the first apparatus and second apparatus are configured such that the fourth fluid stream of the first apparatus combines with adsorbed water from the first water extraction unit of the second apparatus to form a sixth fluid stream of the first apparatus released to atmosphere and the fourth fluid stream of the second apparatus combines with adsorbed water from the first water extraction unit of the first apparatus to form a sixth fluid stream of the second apparatus released to the atmosphere.

15. A method of removing carbon dioxide from ambient air comprising using the apparatus of claim 1.
